(19) United States
(12) Patent Application Publication
(10) Pub. No.: US 2021/0253983 A1
(43) Pub. Date: Aug. 19, 2021

(54) PROCESS FOR MAKING A LIQUID CONSUMER PRODUCT THAT INCLUDES ENZYMES

(71) Applicant: The Procter & Gamble Company, Cincinnati, OH (US)

(72) Inventors: Sebastian VARGAS, Cincinnati, OH (US); Justin Thomas CACCIATORE, Cincinnati, OH (US); Scott William CAPECI, North Bend, OH (US); Vincent Paul BOEH, Harrison, OH (US)

(21) Appl. No.: 17/171,603

(22) Filed: Feb. 9, 2021

(30) Foreign Application Priority Data
Feb. 11, 2020 (EP) 20156502.5

(51) Int. Cl. C11D 11/00; C11D 3/386; C11D 3/50

(52) U.S. Cl. CPC C11D 11/0094; C11D 3/50; C11D 3/38618

(57) ABSTRACT

Processes for making liquid consumer products that include enzymes. Making products in situ by providing at least first and second liquid feed compositions to a container.

### FIELD OF THE INVENTION

The present disclosure relates to processes for making liquid consumer products that include enzymes. The products are typically made and mixed in situ by providing at least first and second liquid feed compositions to a container.

### BACKGROUND OF THE INVENTION

Traditional industry-scale methods for forming liquid consumer products (e.g., liquid laundry detergents, liquid fabric care enhancers, liquid dish-wash detergents, liquid hard-surface cleaners, and the like) involve mixing multiple raw materials of different colors, density, viscosity, and solubility in large quantities (e.g., through either batch mixing or continuous in-line mixing) to first form a homogenous and stable liquid composition, which is then filled into individual containers, followed subsequently by packaging and shipping of such containers. Although such traditional methods are characterized by high throughput and satisfactory mixing, they nevertheless suffer from lack of flexibility. If two or more different liquid consumer products need to be made using the same production line, the production line needs to be cleaned or purged first before it is used to make a different liquid consumer product. Such cleaning or purging step also generates a significant amount of “waste” liquid that cannot be used in either product.

As an alternative, raw materials or premixes thereof may be added directly to a container in which the consumer product will be sold, thereby offering the manufacturer increased formulation flexibility and opportunities for reduced waste.

Enzymes are a common benefit agent to include in various liquid consumer products, such as liquid detergents. However, it has been found that enzymes are a particularly challenging raw material to add in a mix-in-container fashion. For example, if the enzymes are added first or last as lone premixes in small amounts, they typically are not well dispersed without additional mixing, which costs time and capital. If enzyme premixes are added first and/or diluted with water or certain water-containing fluids, in situ mixing may be improved, but the enzymes may suffer a loss of stability, resulting in lower activity levels. In particular, protease tends to degrade other enzymes (including other molecules of protease, as enzymes are proteins), resulting in formulation inefficiencies and unnecessary costs.

Thus, there is a need to efficiently make liquid consumer products that contain enzymes via a mix-in-container process.

### SUMMARY OF THE INVENTION

The present disclosure relates to process of making liquid consumer products that include enzymes. For example, the present disclosure relates to a process for making a liquid consumer product in a container, where the method includes the steps of: (A) providing a container that has an opening, wherein the total volume of the container ranges from about 10 ml to about 10 liters; (B) partially filling the container with a first liquid feed composition to from about 0.01% to about 75% of the total volume of the container, the first liquid feed composition including an enzyme, a first adjunct, and less than about 40% water; (C) subsequently, filling the remaining volume of the container, or a portion thereof, with a second liquid feed composition, the second liquid feed composition being different from the first liquid feed composition, the second liquid feed composition including at least a second adjunct.

### BRIEF DESCRIPTION OF THE DRAWINGS

The figures herein are illustrative in nature and are not intended to be limiting.

FIG. 1 shows an exemplary manufacturing system as described in the present disclosure.

### DETAILED DESCRIPTION OF THE INVENTION

The present disclosure relates to processes for making enzyme-containing liquid consumer products in a container. More specifically, the present disclosure provides an in situ liquid mixing process, i.e., two or more liquid raw materials are mixed directly inside a container (e.g., a bottle, a pouch or the like) that is designated for housing a finished liquid consumer product during shipping and commercialization of such product, or even during usage after such product has been sold.

In sum, a first liquid feed composition, which contains enzymes, may be added to the container in one or more filling steps, and a second liquid feed composition may be subsequently added to the container. It has been found that controlling the amount of water and/or nonaqueous diluent present in the first liquid feed composition can result in improved enzyme stability, even when protease and optionally other enzymes are present. Furthermore, selecting certain amounts, ratios, and/or filling rates of the first and second liquid feed compositions can result in improved mixing profiles, thereby reducing the necessity for separate or additional mixing operations.

The processes, materials, and compositions of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, the phrase “dish care composition” includes compositions and formulations designed for treating dishes, glassware, and/or flatware. Such compositions include but are not limited to hand dishwashing compositions and automatic dishwashing compositions.

As used herein, the phrase “hard surface cleaner” includes composition and formulations designed for treating and/or cleaning hard surfaces such as bathroom surfaces, glass surfaces, countertops, walls, and floors. The target hard surfaces may comprise ceramic, fiber glass, glass, polyurethane, metallic surfaces, plastic surfaces, and laminates of all the above.

As used herein, the term “in situ” refers to real-time mixing that occurs inside a container (e.g., a bottle or a pouch) that is designated for housing a finished liquid consumer product (e.g., a liquid laundry detergent, a liquid fabric care enhancer, a liquid dish-wash detergent, a liquid hard-surface cleaner, and the like) during shipping and commercialization of such product, or even during usage after such product has been sold. In situ mixing of the present invention is particularly distinguished from the in-line mixing that occurs inside one or more liquid pipelines that are positioned upstream of a container, and preferably upstream of the filling nozzle(s). In situ mixing is also distinguished from the batch mixing that occurs inside one or more mixing/storage tanks that are positioned upstream of the liquid pipelines leading to a container suitable for selling or using.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Process of Making a Liquid Consumer Product

The present disclosure relates to a process for making a liquid consumer product in a container. In broad strokes, the process may include the steps of providing a container, partially filling the container with a first liquid feed composition that includes enzymes, and subsequently filling the remaining volume of the container, or a portion thereof, with a second liquid feed composition. The steps and compositions are described in more detail below.

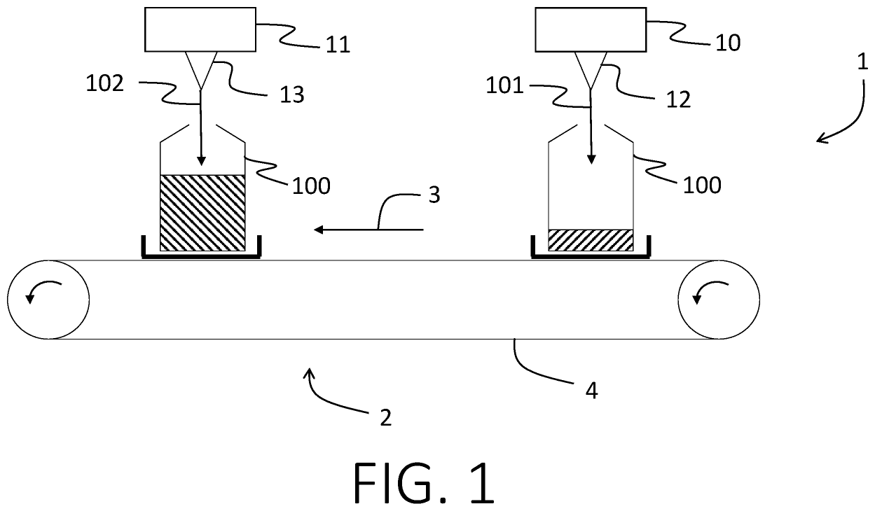

The processes of the present disclosure may take place on a single manufacturing system. An exemplary manufacturing system 1 is shown in FIG. 1. The manufacturing system 1 may include a conveyor system 2, which may be capable of moving a container 100 in a machine direction 3. The conveyor system 2 may include a belt, a track, or other suitable system 4 capable of moving the container(s). The manufacturing system 1 may comprise a linear synchronous motor (LSM) based system that facilitates propulsion of vehicles, which may hold the containers, along the track using electromagnetic force (EMF). The manufacturing system 1 may comprise a system in which the vehicles are propelled in some other manner, such as by individual servo motors. The container(s) 100 may follow a single preset path on the system. The manufacturing system 1 may provide multiple and/or variable paths for the containers. For example, a path may lead to certain filling stations but not others.

The manufacturing system 1 may include a plurality of filling stations 10, 11. A filling station 10, 11 may include one or more nozzles through which one or more compositions may be dispensed into a container. Typically, one nozzle will be associated with one composition. For example, a first liquid feed composition 101 may be provided via a first nozzle 12 to a container 100 at a first filling station 10. A second liquid feed composition 102 may be provided via a second nozzle 13 to the container 102 at a second filling station 11. Certain nozzles may allow for simultaneous provision of more than one composition. A filling station may also include multiple nozzles, each of which may provide a composition to a container, either simultaneously or in sequence.

A container 100 may stop at one, preferably only at some, or even all of the filling stations 10, 11 of the manufacturing system. Requiring the container to stop at only some of the filling stations allows for greater formulation flexibility, meaning that multiple types of consumer products may be manufactured on the same manufacturing system, even simultaneously—one container may go to certain filling stations and/or be filled with certain compositions, while a second container may go to different filling stations and/or be filled with different compositions.

The first liquid feed composition 101 may be provided at one or more filling stations. The first liquid feed composition 101 may be provided by one or more nozzles. The first liquid feed composition 101 may be provided at two or more filling stations, and/or by two or more nozzles.

The second liquid feed composition 102 may be provided at one or more filling stations. The second liquid feed composition 102 may be provided by one or more nozzles. The second liquid feed composition 102 may be provided at two or more filling stations, and/or by two or more nozzles.

At any given filling station, the filling time, for example when the second liquid feed composition 102 is provided to the container 100, may range from about 0.1 second to about 20 seconds, or from about 0.5 to about 10 seconds, or from about 0.5 to about 5 seconds, preferably from about 0.5 second to about 4 seconds, and more preferably from about 1 second to about 3 seconds. Typically, faster times may be preferred for efficiency, and/or a certain minimum of filling time may be desired to improve accuracy of placement and/or volume provided.

Material, such as the first and second liquid feed compositions 101, 102, may be provided to the container 100 at a limited number of filling stations and/or by a limited number of nozzles. It may be desirable to limit the number of filling stations and/or nozzles to balance formulation flexibility against manufacturing complexity. Material may be provided to the container at a total of from 2 to 10, or from 2 to 8, or from 2 to 6, filling stations. Material may be provided to the container via a total of from 2 to 10, or from 2 to 8, or from 2 to 6, nozzles.

One or more of the nozzles may be connected to one or more flow-controlling devices for controlling the flow rates of one or more liquid flows generated by the nozzles. The one or more flow-controlling devices may be selected from the group consisting of valves, pistons, servo-driven pumps, and combinations thereof. The one or more flow-controlling devices may comprise one or more servo-driven pumps.

The first and/or second liquid feed compositions may be provided with a dynamic flow profile. The dynamic flow profiles are preferably mass-dependent, volume-dependent, and/or time-dependent, and may include: (a) a ramping-up section, which is defined by an increasing flow rate of the liquid feed at the beginning of a filling step; and/or (b) a ramping-down section, which is defined by a decreasing flow rate of the liquid feed at the end of a filling step.

The first and/or second liquid feed composition may be provided to a container at a particular peak flow rate. The peak flow rate of the second liquid feed composition may be greater than the peak flow rate of the first liquid feed composition. It may be desirable to have a relatively lower peak flow rate for the first liquid feed composition in order to be more precise with the amount of enzymes provided, which are typically present at very low levels of active ingredient. It may be desirable to have a relatively greater peak flow rate for the second liquid feed composition in order to facilitate in situ mixing. The peak flow rate for the first and/or the second liquid feed composition may be from about 5 mL/second to about 10 L/second, or from about 25 mL/second to about 10 L/second, or from about 50 mL/second to about 10 L/second, or from about 100 mL/second to about 5 L/second. The peak flow rate for the first liquid feed composition may be from about 1 mL/second, or from about 5 mL/second, or from about 10 mL/second to about 100 mL/second, or to about 75 mL/second. The peak flow rate for the second liquid feed composition may be greater than 500 mL/second, or from about 500 mL/second to about 5 L/second, or from about 750 mL/second to about 2.5 L/second. The peak flow rate of the second liquid feed composition may be greater than the peak flow rate for the first liquid feed composition.

Some manufacturing systems may include a mixing station in addition to the filling stations. At such mixing stations, the container may be externally agitated (for example, by shaking, spinning, and/or tumbling the container) or internally agitated (for example, by stirring) in order to better homogenize the final product composition.

However, when the amounts and/or flow rates of the first and second liquid feed compositions are properly selected, the liquid consumer product may become adequately mixed in situ due to the turbulence of the addition process. Thus, the manufacturing system may not include a dedicated mixing station, and/or the process may not include a specific mixing step. The absence of such mixing stations or steps can save on capital and/or reduce manufacturing time. Despite the possible absence of a mixing station and/or a mixing step, it is understood that at least some mixing may occur when material is provided to the container, when the container moves on the manufacturing system (including stops and starts, if any), when the container is closed or sealed, and/or removed from the manufacturing system, for example to be placed on or in secondary packaging.

In order to minimize the error margin associated with the dynamic filling profile of the present invention, it may be desirable to control aeration in the compositions being provided to the container, for example at least the second liquid feed composition. A composition, for example the second liquid feed composition, may be characterized by an Aeration Level of 5% or less by volume, preferably of 3% or less by volume, more preferably of 2% or less by volume, and most preferably of 1% or less by volume. Preferably, aeration in the first liquid feed composition is also controlled in a similar manner.

Controlled aeration can be achieved prior to filling by placing the liquid feed compositions in de-aeration tanks for an extended period of time, either under atmospheric pressure or under vacuum conditions, so as to allow trapped air bubbles to be released from such liquid feed compositions. Quantification of aeration levels in the compositions is by way of a hydrometer assessing the specific gravity between aerated and un-aerated compositions under the atmospheric pressure.

### Container

The process of the present disclosure may include the step of providing a container that has an opening. The total volume of the container may range from about 10 ml to about 10 liters, or from about 100 mL to about 6 liters.

The container according to the present disclosure may be a container that is specifically designated for housing a finished liquid consumer product during shipping and commercialization of such product, or even during usage after such product has been sold. Suitable containers may include pouches (especially standup pouches), bottles, jars, cans, cartons that are water-proof or water-resistant, and the like.

Such container typically includes an opening through which liquids (either liquid raw materials or the finished liquid consumer products) can be filled into and dispensed from it. The opening can have different geometries and various cross-sectional shapes. For example, the opening be tubular or cylindrical with a substantial height and a circular or nearly circular cross-section. For another example, the opening may have a substantial height but an oval, triangular, square, or rectangular cross-section. For yet another example, the opening may have a minimal height that is negligible and is therefore only defined by its cross-sectional shape. Such opening has a center point or centroid. In a conventional liquid filling process, one or more liquid filling nozzles are placed either at such centroid or in its vicinity (e.g., either slightly above it or below it) for generating one or more vertical liquid influxes into the container.

The container also has a supporting plane, which is defined by three or more points upon which the container can stand alone stably, regardless of the shape or contour of its supporting surface. The presence of such a supporting plane does not require that the container have a flat supporting surface. For example, a container may have a concaved supporting surface, while the outer rim of such concave supporting surface defines a supporting plane upon which the container can stand alone stably. For another example, a container may have a supporting surface with multiple protrusions, while three or more such protrusions define a supporting plane upon which the container can stand alone stably.

The container may also have a top end, an opposing bottom end, and one or more side walls that extend between the top end and the bottom end. The above-mentioned opening is typically located at the top end of the container. The above-mentioned supporting plane can be located at the opposing bottom end of the container and is thus defined by a bottom surface of such container (e.g., a typical up-standing liquid bottle that stands on its bottom end). Alternatively, the above-mentioned supporting plane can be located at the top end of the container and is thus defined by a top surface of such container (e.g., an inverse liquid bottle that stands on its top end).

The container may also have a longitudinal axis that extends through the centroid of the above-mentioned opening and is perpendicular to the above-mentioned supporting plane. Please note that although preferred, it is not necessary for the container to have an elongated shape, i.e., the longitudinal axis is not defined by the shape of the container, but is rather defined by the location of the centroid of the container opening and the supporting plane of the container.

Such container may further contain one or more side walls between the top end and the bottom end. For example, such container may be a cylindrical or near cylindrical bottle with one continuous curved side wall that connects its top end and its bottom end, which defines a circular or oval shaped bottom surface. For another example, the container may be a standup pouch with two planar side walls that meet at its bottom end to form an almond-shaped bottom surface as well as at its top end to form a straight-line opening/closure. Further, the container may have three, four, five, six or more planar or curved side walls that connect the top end and the bottom end.

The container of the present disclosure may be filled with two or more different liquid feed compositions, which will mix in situ inside such container. Such liquid feed compositions may differ in any aspect, e.g., colors, density, viscosity, and/or solubility, that may potentially lead to inhomogeneity or phase separation in the resulting mixture.

### First Liquid Feed Composition

The process of the present disclosure may include partially filling the container with a first liquid feed composition. The first liquid feed composition may include an enzyme. The first liquid feed composition may further include a first adjunct. The first liquid feed composition may include a relatively limited amount of water, if any—for example, less than about 40% water.

The container may be partially filled with the first liquid feed composition to from about 0.1% to about 75%, or from about 0.5% to about 50%, or from about 1% to about 25%, or from about 2% to about 20%, or from about 3% to about 10%, of the total volume of the container. The first liquid feed composition may be provided at a level of at least about 1%, or at least about 2%, or at least about 3%, or at least about 4%, or at least about 5%, of the total volume of the container. The amount of first liquid feed composition provided to the container may be at least 1 mL, or at least about 5 mL, or at least about 10 mL, or at least about 25 mL, or at least about 50 mL, or at least about 75 mL, or at least about 100 mL. It may be desirable to have at least a minimum amount of the first liquid feed composition in the container before the second liquid feed composition is added to facilitate adequate mixing.

The first liquid feed composition may include less than about 40%, or less than about 30%, or less than about 25%, of water. It is believed that excessive amounts of water may contribute to enzyme instability in the first liquid feed composition. Additionally, it may be preferred to keep water levels to a minimum for sustainability, formulation space, and/or stability reasons.

The enzymes of the first liquid feed composition may include a protease enzyme, a non-protease enzyme, or a combination thereof. The enzymes preferably include at least a protease enzyme. The enzymes may include a protease enzyme and at least one non-protease enzyme. A combination of enzymes may be preferred to provide a broader spectrum of cleaning/treatment benefits. The first liquid feed composition may comprise a non-protease enzyme and may be free of a protease enzyme, and the second liquid feed composition may comprise a protease enzyme.

The first liquid feed composition may comprise from about 0.0001% to about 10%, or from about 0.001% to about 5%, or from about 0.001% to about 2%, by weight of the first liquid feed composition, of enzymes. When the first liquid feed composition comprises enzymes, the first liquid feed composition may be provided in an amount sufficient to provide 0.0001% to about 5%, or from about 0.001% to about 2%, by weight of the liquid consumer product, of enzymes to the liquid consumer product.

The protease enzyme may be selected from metalloproteases and serine proteases, such as including neutral or alkaline microbial serine proteases, such as subtilisins (EC 3.4.21.62). The protease may be a trypsin-type or chymotrypsin-type protease. The protease may be of microbial origin, such as of bacterial origin or of fungal origin. The protease may be a chemically or genetically modified mutant or variant of a wild type.

The one or more non-protease enzymes may be selected from peroxidases, cellulases (which, as used herein, includes enzymes that break down cellulose, hemicellulose, components of cellulose, or components of hemicellulose; such enzymes may include typical cellulases, hemicellulases, xyloglucanases, xylanases, or mixtures thereof), lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof, preferably amylase, mannanase, lipase, cellulase, pectate lyase, or mixtures thereof.

Particularly preferred may be a mixture of protease and one or more of amylase, mannanse, lipase, cellulase, pectate lyase, or mixtures thereof.

The first adjunct may be a benefit agent (such as a surfactant), an aesthetic agent (such as a colorant or pearlescent), or a processing or stability aid (such as a solvent or structurant). The first adjunct may be in liquid form, or substantially liquid form, such as a suspension or emulsion. The first adjunct may serve as a diluent of the enzymes, preferably a non-aqueous diluent. The amount of the first adjunct may be the same or greater than the amount of water in the first liquid feed composition. The presence of the first adjunct material can facilitate improved in situ mixing and/or stability of the enzymes.

The first adjunct may comprise comprises perfume, colorants, organic solvents, surfactants, opacifiers, pearlescent aids, brighteners, bleaches, bleach activators, catalysts, chelant, builder, polymer, structurant, or mixtures thereof. The first adjunct may comprise perfume, colorant, organic solvent, surfactant, or mixtures thereof. The first adjunct may be present in an amount that is at least about 50%, or at least about 60%, or at least about 70%, by weight of the first liquid feed composition.

The first adjunct may comprise an organic solvent. The organic solvent may be selected from propylene glycol, dipropylene glycol, phenoxy ethanol, diethylene glycol, glycerin, isopropyl myristate, polyethylene glycol, an alkanolamine (such as monoethanolamine or triethanolamine), or combinations thereof. The organic solvent may comprise propylene glycol.

Among other things, it is believed that organic solvents, such as propylene glycol, facilitate enzyme stability, particularly when there is about the same amount or greater of organic solvent compared to water in the first feed composition. The weight ratio of the organic solvent to the water in the first liquid feed composition may be from about 0.75:1, or from about 1:1, or from about 1.1:1, or from about 1.2:1, or from about 1.3:1, to about 20:1, or to about 10:1, or to about 5:1, or to about 3:1, or to about 2:1.

The first liquid feed composition may include perfume. The perfume may comprise neat perfume, encapsulated perfume, perfume premixed with a liquid carrier, or mixtures thereof. Perfumes may improve the aesthetics of the liquid consumer product, processes using the product, or the fabrics treated with the composition. Encapsulated perfume may be preferred for long-lasting scent benefits, as the encapsulates may rupture to release the perfume upon abrasion and/or movement.

As used herein, the term “perfume” encompasses the perfume raw materials (PRMs) and perfume accords. The term “perfume raw material” as used herein refers to compounds having a molecular weight of at least about 100 g/mol and which are useful in imparting an odor, fragrance, essence or scent, either alone or with other perfume raw materials. As used herein, the terms “perfume ingredient” and “perfume raw material” are interchangeable. The term “accord” as used herein refers to a mixture of two or more PRMs. Typical PRM comprise inter alia alcohols, ketones, aldehydes, esters, ethers, nitrites and alkenes, such as terpene.

The first liquid feed composition may comprise from about 0.1% to about 50%, or from about 0.1% to about 25%, or from about 0.1% to about 20%, or from about 0.1% to about 10%, or from about 0.1% to about 5%, preferably from about 0.5% to about 4%, more preferably from about 1% to about 3%, by weight of the first liquid feed composition, of perfume. In some cases, it may be desirable for the composition to be relatively unscented. In such cases, no additional perfume is added, and the composition may comprise less than 0.1%, or even zero percent, of perfume.

The compositions may comprise encapsulated perfume. The encapsulated perfume may be formed by at least partially surrounding perfume materials with a wall material. The capsule wall material may comprise: melamine, polyacrylamide, silicones, silica, polystyrene, polyurea, polyurethanes, polyacrylate based materials, polyacrylate esters based materials, gelatin, styrene malic anhydride, polyamides, aromatic alcohols, polyvinyl alcohol, or mixtures thereof. The melamine wall material may comprise melamine crosslinked with formaldehyde, melamine-dimethoxyethanol crosslinked with formaldehyde, and mixtures thereof; encapsulates with such wall materials may be used in combination with a formaldehyde scavenger, such as acetoacetamide, urea, or derivatives thereof. The polyacrylate based wall materials may comprise polyacrylate formed from methylmethacrylate/dimethylaminomethyl methacrylate, polyacrylate formed from amine acrylate and/or methacrylate and strong acid, polyacrylate formed from carboxylic acid acrylate and/or methacrylate monomer and strong base, polyacrylate formed from an amine acrylate and/or methacrylate monomer and a carboxylic acid acrylate and/or carboxylic acid methacrylate monomer, and mixtures thereof.

The perfume capsule may be coated with a deposition aid, a cationic polymer, a non-ionic polymer, an anionic polymer, or mixtures thereof. Suitable polymers may be selected from the group consisting of: polyvinylformaldehyde, partially hydroxylated polyvinylformaldehyde, polyvinylamine, polyethyleneimine, ethoxylated polyethyleneimine, polyvinylalcohol, polyacrylates, a polysaccharide (e.g., chitosan), and combinations thereof.

One or more types of encapsulates, for examples two encapsulate types, wherein one of the first or second encapsulates (a) has a wall made of a different wall material than the other; (b) has a wall that includes a different amount of wall material or monomer than the other; or (c) contains a different amount perfume oil ingredient than the other; or (d) contains a different perfume oil, may be used. Encapsulates may be added to the composition as a slurry.

The first liquid feed composition may comprise a colorant. Liquid colorants and/or colorants that are delivered at least in part via nonaqueous carriers may be preferred to limit the amount of water in the first liquid feed composition. Suitable colorants may include aesthetic dyes, pigments, hueing agents, or mixtures thereof.

Dyes may include azo dyes, anthraquinone dyes, benzofuranone dyes, polycyclic aromatic carbonyl dyes containing one or more carbonyl groups linked by a quinoid system, indigoid dyes, polymethine and related dyes, styryl dyes, di- and tri-aryl carbonium and related dyes, such as diphenylmethane, methylene blue, oxazine and xanthene types; also useful are the phthalocyanines for instance those including di- and trusulfonated types; quinophthalones, sulphur dyes and nitro-dyes. Highly preferred dyes include dyes having low fastness to textiles, sometime termed non-staining dyes. These have high aesthetic effect but do not discolor laundered textiles.

Hueing agents (sometimes referred to as hueing dyes, fabric shading dyes, or bluing or whitening agents) typically provides a blue or violet shade to fabric. Such agent(s) are well known in the art and may be used either alone or in combination to create a specific shade of hueing and/or to shade different fabric types. The hueing agent may be selected from any suitable chemical class of dye as known in the art, including but not limited to acridine, anthraquinone (including polycyclic quinones), azine, azo (e.g., monoazo, disazo, trisazo, tetrakisazo, polyazo), benzodifurane, benzodifuranone, carotenoid, coumarin, cyanine, diazahemicyanine, diphenylmethane, formazan, hemicyanine, indigoids, methane, naphthalimides, naphthoquinone, nitro, nitroso, oxazine, phthalocyanine, pyrazoles, stilbene, styryl, triarylmethane, triphenylmethane, xanthenes and mixtures thereof. The hueing agent may be selected from an azo agent, a triarylmethane agent, a triphenylmethane agent, or mixtures thereof.

The first liquid feed composition may comprise surfactant. The surfactant may be a detersive surfactant selected from anionic surfactant, nonionic surfactant, zwitterionic surfactant, amphoteric surfactant, or combinations thereof. The surfactant may be selected to provide a benefit in the intended end use of the consumer product. The surfactants may be, at least in part, derived from natural sources, such as natural feedstock alcohols.

Suitable anionic surfactants may include any conventional anionic surfactant. This may include a sulfate detersive surfactant, for e.g., alkoxylated and/or non-alkoxylated alkyl sulfate materials, and/or sulfonic detersive surfactants, e.g., alkyl benzene sulfonates. The anionic surfactants may be linear, branched, or combinations thereof. Preferred surfactants include linear alkyl benzene sulfonate (LAS), alkyl ethoxylated sulfate (AES), alkyl sulfates (AS), or mixtures thereof. Other suitable anionic surfactants include branched modified alkyl benzene sulfonates (MLAS), methyl ester sulfonates (MES), and/or alkyl ethoxylated carboxylates (AEC). The anionic surfactants may be present in acid form, salt form, or mixtures thereof. The anionic surfactants may be neutralized, in part or in whole, for example, by an alkali metal (e.g., sodium) or an amine (e.g., monoethanolamine).

The surfactant may include nonionic surfactant. Suitable nonionic surfactants include alkoxylated fatty alcohols, such as ethoxylated fatty alcohols. Other suitable nonionic surfactants include alkoxylated alkyl phenols, alkyl phenol condensates, mid-chain branched alcohols, mid-chain branched alkyl alkoxylates, alkylpolysaccharides (e.g., alkylpolyglycosides), polyhydroxy fatty acid amides, ether capped poly(oxyalkylated) alcohol surfactants, and mixtures thereof. The alkoxylate units may be ethyleneoxy units, propyleneoxy units, or mixtures thereof. The nonionic surfactants may be linear, branched (e.g., mid-chain branched), or a combination thereof. Specific nonionic surfactants may include alcohols having an average of from about 12 to about 16 carbons, and an average of from about 3 to about 9 ethoxy groups, such as C12-C14 EO7 nonionic surfactant.

The surfactant may include zwitterionic surfactant, such as betaines, including alkyl dimethyl betaine and cocodimethyl amidopropyl betaine, C₈ to C₁₈ (for example from C₁₂ to C₁₈) amine oxides (e.g., C₁₂₋₁₄ dimethyl amine oxide), and/or sulfo and hydroxy betaines, such as N-alkyl-N,N-dimethylammino-1-propane sulfonate where the alkyl group can be C₈ to C₁₈, or from C₁₀ to C₁₄. The zwitterionic surfactant may include amine oxide.

The first liquid feed composition may be provided to the container in a single filling step, for example where the enzyme(s), first adjunct, and water (if any) are added concurrently.

It may be desirable, for example to increase formulation flexibility, to provide the first liquid feed composition in more than one filling step. For example, the processes of the present disclosure may include providing the first liquid feed composition to the container in at least two sub-steps, e.g., at least two filling steps. The at least two sub-steps may include (i) providing a first enzyme, for example as a first enzyme premix, to the container. The sub-steps may further include at least one additional sub-step selected from the following: (ii) providing a second enzyme, for example as a second enzyme premix to the container; (iii) providing the first adjunct, preferably an organic solvent, colorant, perfume, or mixtures thereof, to the container; or (iv) combinations thereof. Enzymes may be the first material added to the container (e.g., sub-steps (i) and/or (ii) may be the first filling steps to occur in the process).

The process may include sub-steps (i) and (ii), e.g., providing a first enzyme and a second enzyme to the container. Sub-steps (i) and (ii) may occur concurrently or in series. The first enzyme and/or the first enzyme premix may include a protease enzyme. The second enzyme and/or the second enzyme premix may include at least one non-protease enzyme.

As the first adjunct may include a plurality of materials, step (iii) of providing a first adjunct may comprise a plurality of filling steps, such as at least two filling steps. One adjunct may be added in a first filling step, and another adjunct may be added in a second filling step. For example, organic solvent may be added in a filling step, perfume may be added in another filling step, and/or colorant may be added in yet another filling step. At least two of the first adjunct materials may be combined in a filling step.

The first liquid feed composition or component thereof (e.g., one or more enzymes) may have a residence time in the container prior to when the second feed composition is provided. The residence time may be from about 1 second, or from about 3 seconds, or from about 5 second, to about sixty minutes, or to about 30 minutes, or to about 10 minutes, or to about 5 minutes, or to about 2 minutes, or to about 60 seconds, or to about 45 seconds, or to about 30 seconds. The container may be transported from one filling station to another filling station during the residence time. Residence time is measured as the time from when a material (e.g., a first liquid feed composition and/or one or more enzymes) is first provided (i.e., when the flow of the first feed stops) to the container to when a second feed composition or component thereof is provided to the container (i.e, when the flow of the second feed starts). The processes of the present disclosure facilitate enzyme stability for relatively long residence times, e.g., from a minute to an hour, which is useful if there is a temporary delay or stoppage on the manufacturing system.

That being said, if the residence time of the first liquid feed composition is for too long a period before the second liquid feed composition is added, the process may include the step of discarding that portion of the first liquid feed composition that is in the container, to protect against potentially degradation and/or instability. What is considered “too long” may depend on the degradation/stability profile of the first liquid feed composition. The first liquid feed composition that has been dispensed to the container may be discarded or otherwise removed from the manufacturing line if the residence time has been more than 1 minute, or more than 5 minutes, or more than 10 minutes, or more than 20 minutes, or more than 30 minutes, or more than 45 minutes, or more than 60 minutes.

### Second Liquid Feed Composition

The processes of the present disclosure may include the step of providing a second liquid feed composition to the container. The second liquid feed composition is different from the first liquid feed composition, for example in terms of type or level of ingredients, viscosity, and/or solubility. The second liquid feed composition may include at least a second adjunct.

The process may include filling the remaining volume of the container, or a portion thereof, with a second liquid feed composition. The second liquid feed composition is typically provided subsequent to the partial filling of the container with the first liquid feed composition, although the first and second liquid feed compositions could be provided concurrently to the container. It is also possible that the second liquid feed composition is added to the container first, followed by addition of the first liquid feed composition; however, this sequence may be less preferred because it may require one or more additional mixing steps, such as external mixing (e.g., tumbling).

The amount (by weight and/or volume) of the second liquid feed composition may be greater than the amount of the first liquid feed composition, which may be preferred to facilitate adequate mixing of the enzymes in the final consumer product. The process may include filling at least at least 50%, or at least 60%, or at least 70%, or at least 80%, or at least 90%, of the total volume of the container with the second liquid feed composition. The weight ratio of the first liquid feed composition to the second liquid feed composition may be less than or equal to 1:1, or from about 1:2 to about 1:1000, or from about 1:2 to about 1:500, or from about 1:2 to about 1:200, preferably from about 1:3 to about 1:100, preferably from about 1:4 to about 1:50, more preferably from about 1:5 to about 1:20, even more preferably from about 1:5 to about 1:10.

The second liquid feed composition may include a relatively greater proportion of water (as weight %) than is present in the first liquid feed composition. The second liquid feed composition may include greater than 40% water, or greater than about 45% water, or greater than about 50% water. The second liquid feed may include less than about 90% water, or less than about 75% water, or less than about 65% water.

The second liquid feed composition may comprise a second adjunct. The second adjunct may not be present in the first liquid feed composition. The second adjunct may be present in both the first and second liquid feed compositions, but not at identical levels.

The second adjunct may include surfactant, a conditioning active, or mixtures thereof, preferably surfactant.

The second liquid feed composition may include surfactant at a level of from about 5% to about 60%, by weight of the second liquid feed composition. As described above, the surfactant may be selected from anionic surfactant, nonionic surfactant, zwitterionic surfactant, amphoteric surfactant, or combinations thereof.

The second liquid feed composition may include a conditioning agent. The conditioning agent may be selected from quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof, preferably selected from quaternary ammonium ester compounds, silicones, or combinations thereof. The second liquid feed composition may include from about 1% to about 50%, or from about 5% to about 30%, by weight of the second liquid feed composition, of the conditioning active.

The second liquid feed composition according to the present disclosure may include an external structurant. External structurants may include non-polymeric crystalline, hydroxy-functional structurants and/or polymeric structurants. Non-polymeric crystalline, hydroxyl functional structurants may comprise a crystallizable glyceride, which may be pre-emulsified to aid dispersion into the final detergent composition. Suitable crystallizable glycerides include hydrogenated castor oil or “HCO” or derivatives thereof, provided that it is capable of crystallizing in the liquid detergent composition. Polymeric structurants may include naturally derived structurants and/or synthetic structurants.

The second liquid feed composition may include an enzyme stabilizer. While an enzyme stabilizer may not be necessary in the first liquid feed composition (for example, due to the relatively low water content), it may be desirable to include enzyme stabilizers as part of the second liquid feed composition, particularly when the final consumer product is formulated to include a relatively higher proportion of water. Suitable enzyme stabilizers may include borates or sources thereof (such as boric acid), a calcium source (e.g., calcium formate), and other known stabilizers.

The second liquid feed composition may include enzymes. The enzymes may be the same or different as the enzymes provided in the first liquid feed composition. Adding additional enzymes in the second liquid feed composition may help to differentiate different product by enzyme type and/or level, particularly when multiple types or amounts of second liquid feed compositions are used.

### Liquid Consumer Product

The processes of the present disclosure relate to methods of making liquid consumer products. As described above, the liquid consumer product contains enzymes.

Suitable liquid consumer products may include any product in which enzymes are suitable, for example for providing an end-use benefit. The liquid consumer product may be a cleaning product. The liquid consumer product may be suitable for domestic, commercial, and/or industrial usage. The liquid consumer product may be suitable for manual operations (e.g., washing by hand) or for automated operations (e.g., washing with an automatic machine).

The liquid consumer product may be a household care product. The liquid consumer product may be a fabric care product, a dish care product, a hard surface cleaner, or a combination thereof. The liquid consumer product may be a fabric care product, such as a heavy duty liquid (HDL) liquid laundry detergent or a pre-treatment product. The liquid consumer product may be a dish care product, such as a hand dishwashing composition or an automatic dishwashing composition.

The liquid consumer product may have a viscosity from about 1 to about 2000 centipoise (1-2000 mPa·s), or from about 200 to about 1400 centipoise, or from about 200 to about 1000 centipoise, or from about 200 to about 800 centipoise (200-1400 mPa·s). The viscosity is determined using a Brookfield viscometer, No. 2 spindle, at 60 RPM/s, measured at 20° C.

The liquid consumer product may be isotropic. The liquid consumer product may be relatively transparent or translucent. The liquid consumer products of the present disclosure may be characterized by a percent transmittance of greater than about 50%, or greater than about 60%, or greater than about 80%, or greater than about 90%, at a wavelength of 570 nm measured at room temperature via a standard 10 mm pathlength cuvette with a Beckman DU spectrophotometer using deionized water as blank, in the absence of dyes and/or opacifiers. Percent transmittance is determined according to the method provided in the Test Methods section.

The liquid consumer product may be characterized by a pH of from about 6.5 to about 9, or from about 7 to about 9, or from about 7.5 to about 8.5. The pH is measured according to the method provided in the Test Methods section.

The liquid consumer product may comprise water. The liquid consumer product may comprise a relatively greater proportion (as weight %) of water than the first liquid feed composition. The liquid consumer product may comprise greater than about 40%, or greater than about 45% water, or greater than about 50% water, by weight of the liquid consumer product.

The liquid consumer product may comprise from about 5% to about 50%, or from about 5% to about 35%, by weight of the composition, of surfactant. Suitable surfactants are described in more detail above.

The liquid consumer product may comprise from about 1% to about 30%, by weight of the composition, of a conditioning active. Suitable conditioning actives are described in more detail above.

The liquid consumer product may be characterized by a “retained activity” of an enzyme, which is an indication of the relative stability of an enzyme over time. Different enzymes may have different degrees of retained activity for a given product after a given time. The liquid consumer product may be characterized, for example, by a retained activity of at least 0.85 after four weeks and/or at least 0.60 after twelve months, for a particular enzyme, such as a cellulase. Relatively greater degrees of retained activity are preferred, as they indicate greater stability and more efficient use of the enzyme.

Retained activity can be determined directly, for example by a product manufacturer, by measuring the enzyme's activity at time zero (which may be when the product is manufactured), and then after a certain time period has elapsed (e.g., four weeks and/or twelve months); retained activity is the activity upon storage divided by the activity at time zero. Alternatively, retained activity can be determined by dividing the enzyme's activity at time X (for example, four weeks and/or twelve months after product manufacture) by the total amount of enzyme present (active and inactive), determined by ELISA Analysis. Test methods for determinations of enzyme activity and ELISA Analysis are provided in the Test Methods section below.

The process may include providing a label or other indicia to the container, for example in the form of a sticker, a shrink sleeve, or direct printing.

The process of the present disclosure may further include a step of closing the container after at least the first and second liquid feed compositions have been added to the container. For example, a cap may be provided to the container to close or seal the opening. The cap may snap or screw onto the container. The container may be heat sealed and/or pressure sealed, for example, when the container is in the form of a pouch. The container may be selectively closeable. Once closed and optionally labeled, the container may be suitable for sale, transport, mailing/shipping, storage, or usage, for example by a consumer.

The container may be provided to secondary packaging. The secondary packaging may comprise a plurality of containers, which may contain same or different consumer products. The secondary packaging may be in the form of a box, a bag, a pallet, or any other suitable packaging.

The present disclosure also relates to a method of making a plurality of liquid consumer products. For example, the method may relate to repeating the steps described above to make a plurality of liquid consumer products (e.g., a first liquid consumer product and a second liquid consumer product) that have the same formulation in each container. The containers may be of the same size, or of different sizes.

The present disclosure also contemplates a method of making a plurality of liquid consumer products, where a first consumer product is different than a second consumer product. The method may include providing first and second liquid feed compositions to a container, which may be a first container, to make a first liquid consumer product. The method may also include providing an alternate first liquid feed composition and a second liquid feed composition to a container, which may be a second container, to make a second liquid consumer product that has a different formulation than the first liquid consumer product. The alternate first liquid feed composition may have a different formula than the first liquid feed composition, for example different enzyme type(s), different enzyme levels, different first adjunct types, different first adjunct levels, and/or different water levels. The second liquid feed composition may be the same for both the first and second liquid consumer products.

Alternatively, the first liquid feed composition may be the same for both the first and the second liquid consumer product, but the second liquid feed compositions may be different (e.g., a second liquid feed composition and an alternate second liquid feed composition). Thus, the method may include providing first and second liquid feed compositions to a container, which may be a first container, to make a first liquid consumer product. The method may also include providing the first liquid feed composition and an alternate second liquid feed composition to a container, which may be a second container, to make a second liquid consumer product that has a different formulation than the first liquid consumer product. The alternate second liquid feed composition may have a different formula than the second liquid feed composition, for example different second adjunct types, different second adjunct levels, and/or different water levels. The difference may include, as second adjunct, different surfactant types and/or surfactant levels.

Different nozzles may be used to dispense the first and alternate first liquid feed compositions. Different nozzles may be used to dispense the second and alternate second liquid feed compositions. Such configurations allow multiple types of products to be made on the same manufacturing line without the need for clean-out between product types.

### Combinations

Specifically contemplated combinations of the disclosure are herein described in the following lettered paragraphs. These combinations are intended to be illustrative in nature and are not intended to be limiting.

A. A process for making a liquid consumer product in a container, the process comprising the steps of: (A) providing a container that has an opening, wherein the total volume of said container ranges from about 10 ml to about 10 liters; (B) partially filling said container with a first liquid feed composition to from about 0.01% to about 75% of the total volume of said container, the first liquid feed composition comprising an enzyme, a first adjunct, and less than about 50% water, by weight of the first liquid feed composition; (C) subsequently, filling the remaining volume of the container, or a portion thereof, with a second liquid feed composition, the second liquid feed composition being different from the first liquid feed composition, the second liquid feed composition comprising at least a second adjunct.

B. The process according to paragraph A, wherein during step (B), the container is partially filled with the first liquid feed composition to from about 0.5% to about 50%, or from about 1% to about 25%, or from about 2% to about 20%, or from about 3% to about 10%, of the total volume of said container.

C. A process according to any of paragraphs A or B, wherein the enzyme comprises a protease enzyme, a non-protease enzyme, or a combination thereof, preferably at least a protease enzyme, more preferably a protease enzyme and one or more non-protease enzymes.

D. A process according to paragraph C, wherein the one or more non-protease enzyme(s) is selected from hemicellulases, peroxidases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof, preferably amylase, mannanase, lipase, cellulase, pectate lyase, or mixtures thereof.

E. A process according to any of paragraphs A-D, wherein the first adjunct comprises perfume, colorants, organic solvents, surfactants, opacifiers, pearlescent aids, brighteners, bleaches, bleach activators, catalysts, chelant, builder, polymer, structurant, or mixtures thereof, preferably wherein the first adjunct comprises perfume, colorant, organic solvent, surfactant, or mixtures thereof, more preferably present in an amount that is at least 50% by weight of the first liquid feed composition.

F. A process according to paragraph E, wherein the first adjunct comprises organic solvent, preferably wherein the organic solvent is selected from propylene glycol, dipropylene glycol, phenoxy ethanol, diethylene glycol, glycerin, isopropyl myristate, polyethylene glycol, an alkanolamine, or combinations thereof, preferably propylene glycol.

G. A process according to paragraph F, wherein the weight ratio of the organic solvent to the water in the first liquid component is from about 0.75:1, or from about 1:1, or from about 1.1:1, or from about 1.2:1, or from about 1.3:1, to about 20:1, or to about 10:1, or to about 5:1, or to about 3:1, or to about 2:1.

H. A process according to paragraph E, wherein the perfume comprises neat perfume, encapsulated perfume, perfume premixed with a liquid carrier, or mixtures thereof.

I. A process according to any of paragraphs A-H, wherein the step of providing the first liquid feed composition to the container comprises at least two sub-steps, preferably wherein the at least two sub-steps comprise:
i) providing a first enzyme premix to the container,
and at least one additional sub-step selected from the following:
ii) providing a second enzyme premix to the container;
iii) providing the first adjunct, preferably an organic solvent, dye, perfume, or mixtures thereof, to the container;
iv) combinations thereof.

J. A process according to paragraph I, the process comprising the sub-steps i) and ii), wherein the first enzyme premix comprises a protease enzyme, and wherein the second enzyme premix comprises one or more non-protease enzymes.

K. A process according to any of paragraphs I or J, wherein the process comprises sub-step iii), wherein at least two materials are added in at least two filling steps.

L. The process according to any of paragraphs A-K, wherein during step (C), at least 50%, or at least 60%, or at least 70%, or at least 80%, or at least 90%, of the total volume of said container is filled with said second liquid feed composition.

M. The process according to any of paragraphs A-L, wherein the second liquid feed composition comprises greater than 40% water.

N. A process according to any of paragraphs A-M, wherein the weight ratio of the first liquid feed composition to the second liquid feed composition is less than or equal to 1:1, or from about 1:2 to about 1:1000, or from about 1:2 to about 1:500, or from about 1:2 to about 1:200, preferably from about 1:3 to about 1:100, preferably from about 1:4 to about 1:50, more preferably from about 1:5 to about 1:20.

O. A process according to any of paragraphs A-N, wherein the first and/or second adjunct, preferably at least the second adjunct, more preferably only the second adjunct, comprises a detersive surfactant, a conditioning agent, or a combination thereof.

P. A process according to paragraph O, wherein the first and/or second adjunct comprises a detersive surfactant selected from anionic surfactant, nonionic surfactant, zwitterionic surfactant, amphoteric surfactant, or combinations thereof.

Q. A process according to paragraph P, wherein the detersive surfactant is present in the second liquid component at a level of from about 5% to about 60%, by weight of the second liquid feed composition.

R. A process according to any of paragraphs A-Q, wherein the first and/or second liquid feed composition further comprises an additional adjunct selected from an external structurant, an enzyme stabilizer, or mixtures thereof.

S. The process according to any of paragraphs A-R, wherein the liquid consumer product comprises greater than about 40%, or greater than about 45% water, or greater than about 50% water.

T. A process according to any of paragraphs A-S, wherein the liquid consumer product is characterized by a retained activity of the enzyme of at least about 0.85, measured four weeks after the liquid consumer product is made.

U. A process according to any of paragraphs A-T, wherein the liquid consumer product is a fabric care product, a dish care product, a hard surface cleaner, or a combination thereof.

V. A process according to any of paragraphs A-U, wherein the process occurs on a manufacturing line having a plurality of filling stations, wherein the first liquid feed composition is provided at one or more filling stations, wherein the second liquid feed composition is provided at one or more different filling stations, and wherein material is provided to the container at a total of from 2 to 10 filling stations.

W. A process according to any of paragraphs A-V, wherein the manufacturing system does not include a dedicated mixing station.

X. The process according to any of paragraphs A-W, wherein the peak flow rate of the first and/or second liquid feed composition ranges from about 5 mL/second to about 10 L/second, or from about 25 mL/second to about 10 L/second, or from about 50 mL/second to about 10 L/second, preferably from about 100 mL/second to about 5 L/second.

### Test Methods

### Percent Transmittance

The Percent Transmittance is measured with a UV-Visible spectrometer such as a Beckman Coulter DU® 800. A standard 10 mm pathlength cuvette is used for the sample measurement and compared to a deionized water blank. Samples are measured in the in the absence of dyes and/or opacifiers, and at a temperature of 20° C.±2° C.

pH

Unless otherwise stated herein, the pH of the composition is defined as the pH of an aqueous 10% (weight/volume) solution of the composition at 20±2° C. Any meter capable of measuring pH to ±0.01 pH units is suitable. Orion meters (Thermo Scientific, Clintinpark—Keppekouter, Ninovesteenweg 198, 9320 Erembodegem—Aalst, Belgium) or equivalent are acceptable instruments. The pH meter should be equipped with a suitable glass electrode with calomel or silver/silver chloride reference. An example includes Mettler DB 115. The electrode should be stored in the manufacturer's recommended electrolyte solution.

The 10% aqueous solution of the composition is prepared according to the following procedure. A sample of 10±0.05 grams is weighted with a balance capable of accurately measuring to ±0.02 grams. The sample is transferred to a 100 mL volumetric flask, diluted to volume with deionized water, and thoroughly mixed. About 50 mL of the resulting solution is poured into a beaker, the temperature is adjusted to 20±2° C. and the pH is measured according to the standard procedure of the pH meter manufacturer. The manufacturer's instructions should be followed to set up and calibrate the pH assembly.

### Enzyme Activity

Methods for testing the activity of various types of enzymes are described below.

In preparation, the following solutions may be prepared. Prepare a diluent solution of 0.5 g calcium chloride dihydrate (Sigma-Aldrich, cat. #C-5080) and 10 g sodium thiosulfate pentahydrate (Sigma-Aldrich, cat. #S-6672) in 1 liter of deionized water (18.2 mega Ohms MΩ or better). Prepare a TRIS buffer of 12.1 g tris-hydroxymethyl-aminomethane (Sigma-Aldrich, cat. #T1503), 1.1 g of calcium chloride dihydrate and 5.0 g sodium thiosulfate pentahydrate, adjust to pH 8.3 with concentrated hydrochloric acid and make up to 1 liter of deionized water. Prepare a working PNA solution by diluting 250 uL of a 1 gram of N-Succinyl-ALA-ALA-PRO-PHE p-nitroanilide (“PNA”; Sigma-Aldrich, cat. #S-7388) per 10 mL dimethyl sulfoxide (J.T. Baker, cat. #JT9224-1) into 25 mL TRIS buffer. Prepare a glycine buffer of 7.5070 g glycine (Sigma-Aldrich, cat #G7126), pH 10 in 1 liter of deionized water. Prepare a galactomannan working solution by diluting 0.4 g AZCL-galactomannan (Megazyme, cat #I-AZGMA) in 100 mL of glycine buffer. Prepare a sodium bicarbonate buffer of 21.0 g sodium bicarbonate (British Drug House, cat #BDH9286.500) and 14.6 g sodium chloride (Sigma-Aldrich, cat #S6014), pH 9.5 in 1 liter of deionized water. Prepare a AZCL-HE-cellulose working solution by diluting 0.9 g AZCL-HE-cellulose (Megazyme, cat #I-AZCEL) in 50 mL sodium bicarbonate buffer.

A. Protease analysis. Protease analysis is carried out by reaction of a protease containing sample with Succinyl-Ala-Ala-Pro-Phe p-nitroanilide resulting in a change in absorbance over time spectrophotometrically. The response is proportional to the level of protease present in the sample. The protease sample is prepared by dilution in diluent solution. The reaction begins by incubation of 250 uL of working PNA solution at 37° C. for 360 seconds then delivery of 25 uL sample preparation and monitoring change in absorbance at 405 nm. The protease active level is determined by relation to a protease level vs. reaction rate calibration established for that specific protease. For example, a reference curve may be established by measuring post-reaction absorbance as described above over a range of known enzyme concentrations, for example, from about 1 mg enzyme/100 g product to about 100 mg enzyme/100 g product.

B. Amylase analysis. The amylase reaction uses a combination of the alpha amylase present in the sample and an alpha glucosidase to react with a modified p-nitrophenylmaltoheptaside containing a terminal glucose unit blocked with an ethylidene group. This terminal blocking inhibits cleavage by the alpha-glucosidase until the initial internal bonds can be cleaved by the alpha-amylase followed by alpha-glucosidase. The increase in absorbance (@ 405 nm) per minute, facilitated by the release of pNP by the alpha-glucosidase, is directly proportional to the alpha-amylase activity in the sample. The amylase sample is prepared by dilution in diluent solution. The reaction reagents are provided in Infinity amylase reagent (Thermo Fisher Scientific, cat. #986540). The reaction begins by incubation of 190 uL of Infinity amylase reagent at 37° C. for 360 seconds then delivery of 50 uL of the diluted sample preparation and monitoring the change in absorbance at 405 nm spectrophotometrically. The amylase active level is determined by relation to an amylase level vs. reaction rate calibration established for that specific amylase. For example, a reference curve may be established by measuring post-reaction absorbance as described above over a range of known enzyme concentrations, for example, from about 1 mg enzyme/100 g product to about 100 mg enzyme/100 g product.

C. Mannanase analysis. Mannanase analysis is carried out by reaction of a mannanase containing sample with a suspension of dyed Azurine-Crosslinked Polysaccharide (galactomannan) resulting in an absorbance. The absorbance is proportional to the level of mannanase present in the sample. The mannanase sample is prepared by dilution in diluent solution. The reaction begins by incubation of 1500 uL of working AZCL-galactomannan working solution at 50° C. for 20 minutes while agitated at 850 RPM with delivery of 100 uL sample preparation, then centrifugation at 13,300 RPM and measuring absorbance of top portion at 600 nm. The mannanase active level is determined by relation to a mannanase level vs. absorbance calibration established for that specific mannanase. For example, a reference curve may be established by measuring post-reaction absorbance as described above over a range of known enzyme concentrations, for example, from about 1 mg enzyme/100 g product to about 10 mg enzyme/100 g product.

D. Cellulase analysis. Cellulase analysis is carried out by reaction of a cellulase containing sample with a suspension of dyed Azurine-Crosslinked hydroxyethyl cellulose AZCL-HE-cellulose resulting in an absorbance. The absorbance is proportional to the level of cellulase present in the sample. The cellulase sample is prepared by dilution in diluent solution. The reaction begins by incubation of 1000 uL of working AZCL-HE-Cellulose working solution at 40° C. for 60 minutes while agitated at 850 RPM with delivery of 100 uL sample preparation, then centrifugation at 13,300 RPM and measuring absorbance of top portion at 590 nm. The cellulase active level is determined by relation to a cellulase level vs. absorbance calibration established for that specific cellulase. For example, a reference curve may be established by measuring post-reaction absorbance as described above over a range of known enzyme concentrations, for example, from about 1 mg enzyme/100 g product to about 5 mg enzyme/100 g product.

### ELISA Analysis

The presently described Enzyme Linked Immuno-Sorbent Assay (or “ELISA”) Analysis method is used to determine the total amount of a particular protein, such as an enzyme, that is present is a composition. When measuring for an enzyme, the test method provides the sum total of active and inactive enzyme.

In preparation, the following solutions may be prepared. Prepare a capture buffer of 1.51 g sodium carbonate (Sigma-Aldrich, cat. #223530) and 2.93 g sodium bicarbonate (Sigma-Aldrich, cat. #S-6014), with pH 9.6±0.2 made to volume with 1 L deionized water (18.2 mega Ohms MS1 or better). Prepare a wash buffer of 29.22 g sodium chloride (J.T. Baker cat. #3628-01) and 1 g Bovine Serum Albumin (Sigma-Aldrich, cat #A-7888), adjust pH to 8.0 with concentrated hydrochloric acid and make to 1 L with deionized water then add 0.5 mL Tween 20 (Sigma-Aldrich cat. #T-9039). Prepare a citrate/Phosphate buffer of 7.30 g citric acid (VWR, cat. #97062) and 23.87 g Sodium phosphate dibasic dodecahydrate (Sigma-Aldrich cat. #71649), adjust pH to 5.0 with concentrated sodium hydroxide or hydrochloric acid and make up to 1 L of deionized water. Prepare a sample preparation buffer of 0.93 g tris-hydroxymethyl-aminomethane (Sigma-Aldrich, cat. #T1503) and 0.147 g calcium chloride dihydrate (Sigma-Aldrich, cat. #C-5080) and 4.96 g sodium thiosulfate pentahydrate (Sigma-Aldrich, cat. #S-6672) and 1 g bovine serum albumin in 1 liter of deionized water, adjust pH to 8.0 with concentrated hydrochloric acid. Prepare a blocking solution of 2 g bovine serum albumin dissolved in 100 mL of sample preparation buffer. Prepare a Orthophenylene diamine solution of 30 mg of Orthophenylene diamine (Sigma-Aldrich, cat. #P-4664) dissolved in 30 mL of citrate/Phosphate buffer at time of analysis. Prepare a 0.1% capture antibody solution of an immuno-specific antibody generated from a host species diluted in capture buffer. Prepare a 0.1% detecting antibody solution of an immuno-specific detecting antibody generated from a host species diluted in blocking solution. Prepare a 0.1% antigen-specific reporter-label solution diluted in blocking solution. Prepare a 1M sulfuric acid solution.

ELISA Analysis is carried out by application of 100 uL of a capture antibody solution incubated for at least 24 hours @ 4 C in a 350 uL well plate and removed with 300 uL wash buffer. Sample is prepared by dilution in sample preparation buffer. Then 100 uL of sample is added to the well plate and incubated for 90 minutes @ 37 C, then removed with 300 uL wash buffer. A 0.1% detecting antibody solution is added to the well at 100 uL and incubated for 60 minutes @ 37 C and removed with 300 uL of wash buffer. Next, 100 uL of a 0.1% antigen-specific reporter-label solution is added to the well and incubated for 60 minutes @ 37 C then removed with 300 uL wash buffer. Further wash the well with another 300 uL of citrate/Phosphate buffer and tap dry. Add 100 uL of Orthophenylene diamine solution to the well. Allow color to develop within the range of a concurrent reference curve established by an absorbance over a range of known enzyme concentrations, for example, from about 0.2 ng/mL to about 6 ng/mL. After desired color development has been attained an addition of 100 uL of the 1M sulfuric acid solution is added to the same well. Absorbance is read at 492 nm.

### EXAMPLES

The examples provided below are intended to be illustrative in nature and are not intended to be limiting.

### Example 1. Exemplary Process of Making a Liquid Consumer Product

An empty end-use consumer container (e.g., a rigid plastic bottle with a handle; suitable for containing TIDE™ liquid laundry detergent; interior volume is approximately 3 liters) is presented to a first dispensing station. At this first dispensing station, a first liquid feed composition is added to the package at a rate in excess of 10 mL/s, to a total volume of 7% of the container's volume. The first liquid feed composition contains a protease enzyme, a non-protease enzyme (approximately 1% of first liquid feed composition by mass of first composition), a perfume (14% by mass of first liquid feed composition), a dye (0.2% by mass of first liquid feed composition), organic solvents (61.8% by mass of first liquid feed composition), and water (23% by mass of first liquid feed composition).

Upon completion of this operation, the end-use consumer package is indexed to a second dispensing station, in which a second liquid feed composition is added to the end use consumer product. This second liquid feed composition is designed to fill the remaining approx. 93% of the containers at a sufficiently high rate 200 mL/s to 3000 mL/s, or 500 to 2500 mL/s, or 750 to 1250 mL/s. Such high rates promote turbulence of the liquid in the container while filling and promote blending of the first liquid feed composition with the second liquid feed composition to produce a homogenous product.

For asymmetric bottles, or bottles with a complete inner geometry, it can be advantageous to design a filling nozzle for the second liquid feed composition such that the energy from this dispensing operation is sufficiently broadcast throughout the spatial constraints of the container to promote homogenous mixing, for example by dispensing the composition in multiple directions within the container.

Before or after filling, the container may be decorated and/or labeled as desired.

### Example 2. Exemplary Process of Making a Liquid Consumer Product

A liquid consumer product is made according to the process described in Example 1, except that the protease enzyme and the non-protease enzyme are added to the container as separate compositions. The protease enzyme composition and the non-protease enzyme composition are added simultaneously.

### Example 3. Exemplary Process of Making a Liquid Consumer Product

A liquid consumer product is made according to the process described in Example 1, except that the protease enzyme and the non-protease enzyme are added to the container as separate compositions. The protease enzyme composition and the non-protease enzyme composition are added sequentially. In some cases, the protease enzyme composition is added prior to the non-protease enzyme composition. In other cases, the non-protease enzyme composition is added prior to the protease enzyme composition.

### Example 4. Exemplary Process of Making a Liquid Consumer Product

A liquid consumer product is made according to the process described in Example 1 and is further externally mixed, for example by tumbling and/or shaking.

### Example 5. Enzyme Stability

The following experiment tests the effect of water level and/or water:solvent ratios in the first liquid feed composition on enzyme stability upon storage of final product.

For Legs A-D, various enzyme premixes are provided to containers (e.g., a detergent bottle). The enzyme premixes (e.g., a first feedstock composition) vary in water levels and/or solvent levels (i.e., propanediol). A short period of time later, a base detergent composition (e.g., a second feedstock composition) that contains, among other things, anionic surfactant and an enzyme stabilizer (sodium tetraborate) is added to the containers to form mixed, finished liquid detergent products. The finished products are stored for four weeks. After the four weeks, the compositions are evaluated for retained enzyme activity (specifically, for the retained activity of Whitezyme®, a xyloglucanase enzyme available from Novozymes A/S), and approximate enzyme decay rates of the enzyme in each leg is calculated. The lower the retained enzyme activity, the greater the enzyme decay rate. For product stability and performance reasons, greater retained activities and relatively low rates of decay are desirable.

Based on the assumption that the enzyme decay rates in the finished products are the same, approximate enzyme decay rates for the time the premix is alone in the container (prior to the addition of the detergent base composition) are calculated.

For Legs A and B, protease is added to the container separately from the other enzyme(s). In Leg A, sodium tetraborate (a known enzyme stabilizer) is added to the protease prior to combination with the other enzymes in the container. In Leg B, sodium borate is added to the other enzymes prior to combination with the protease in the container.

As a further comparison, a control detergent composition is made by a traditional batch process, in which enzymes are added to a base composition (having an enzyme stabilizer) and mixed; the retained enzyme activity of the control composition is also determined upon four weeks storage.

Results are provided below in Table 1.

TABLE 1

| | | Ratio of | | Retained |
|---|---|---|---|---|
| | Total Water | Solvent | | Enzyme |
| | Fraction in | to Water in | Calculated Decay | Activity |
| | Premix | Premix | Rate in Premix | at 4 weeks |
| Leg | (by mass) | (by mass) | (Whitezyme ®) | (Whitezyme ®) |
| A | 0.280 | 1.334 | .202 | 0.873 |
| B | 0.280 | 1.334 | .249 | 0.833 |
| C | 0.280 | 1.529 | .192 | 0.883 |
| D | 0.229 | 2.420 | .145 | 0.925 |
| Control* | N/A | N/A | N/A | 0.935 |
| (comp.) | | | | |

*Made via a batch process

Based on the results in Table 1, greater ratios of solvent to water in the premix and relatively lower total water fraction in the premix provide relatively lower calculated decay rates in the premix and relatively greater retained enzyme activity in the finished product after storage. For example, Leg D shows a retained enzyme activity after 4 weeks that is very close to that of the Control.

Additionally, the results of Legs A and B in Table 1 indicate that in environments that have relatively higher amounts of water, adding an enzyme stabilizer to protease may be relatively more beneficial to maximizing retained enzyme activity compared to adding an enzyme stabilizer to other enzymes prior to combination.

### Example 6. Exemplary Product Formulations

Table 2, below, shows exemplary formulations of consumer product compositions (specifically heavy-duty liquid laundry detergent formulations) that may be made according to the present disclosure. Amounts provided are by weight % of active, unless otherwise indicated.

TABLE 2

| | 1 | 2 | 3 | 4 | 5 | 6 | 7 |
|---|---|---|---|---|---|---|---|
| AE18S | 6.77 | 2.16 | 1.36 | 1.30 | | | |
| AE3S | | 3.0 | | | 0.45 | | |
| LAS | 0.86 | 2.06 | 2.72 | 0.68 | 0.95 | | |
| HSAS | 1.85 | 2.63 | 1.02 | | | | |
| AE9 | 6.32 | 9.85 | 10.2 | 7.92 | | | |
| AE8 | | | | | | | 35.45 |
| AE7 | | | | | 8.40 | 12.44 | |
| C1214 dimethyl Amine | 0.3 | 0.73 | 0.23 | 0.37 | | | |
| C1218 Fatty Acid | 0.80 | 1.90 | 0.60 | 0.99 | 1.20 | | 15.00 |
| Citric Acid | 2.50 | 3.96 | 1.88 | 1.98 | 0.9 | 2.5 | 0.6 |
| Optical Brightener 1 | 1.0 | 0.8 | 0.1 | 0.3 | 0.05 | 0.5 | 0.001 |
| Optical Brightener 3 | 0.001 | 0.05 | 0.01 | 0.2 | 0.5 | | |
| Sodium formate | 1.6 | 0.09 | 1.2 | 0.04 | 1.6 | 1.2 | 0.2 |
| DTI 1 | 0.32 | 0.05 | | 0.6 | 0.1 | 0.6 | 0.01 |
| DTI 2 | 0.32 | 0.1 | 0.6 | 0.6 | 0.05 | 0.4 | 0.2 |
| Sodium hydroxide | 2.3 | 3.8 | 1.7 | 1.9 | 1.7 | 2.5 | 2.3 |
| Monoethanolamine | 1.4 | 1.49 | 1.00 | 0.7 | | | |
| Diethylene glycol | 5.5 | | 4.1 | | | | |
| Chelant 1 | 0.15 | 0.15 | 0.11 | 0.07 | 0.5 | 0.11 | 0.8 |
| 4-formyl-phenylboronic acid | | 0.05 | 0.02 | 0.01 | | | |
| Sodium tetraborate | 1.43 | 1.50 | 1.10 | 0.75 | | 1.07 | |
| Ethanol | 1.54 | 1.77 | 1.15 | 0.89 | | 3.00 | 7.00 |
| Polymer 1 | 0.1 | | | | | | 2.00 |
| Polymer 2 | 0.3 | 0.33 | 0.23 | 0.17 | | | |
| Polymer 3 | | | | | | | 0.8 |
| Polymer 4 | 0.8 | 0.81 | 0.60 | 0.40 | 1.0 | 1.0 | |
| 1,2-Propanediol | | 6.6 | | 3.3 | 0.5 | 2.0 | 8.0 |
| Structurant | 0.1 | | | | | | 0.1 |
| Perfume | 1.6 | 1.1 | 1.0 | 0.8 | 0.9 | 1.5 | 1.6 |
| Perfume encapsulate | 0.1 | 0.05 | 0.01 | 0.02 | 0.1 | 0.05 | 0.1 |
| Protease | 0.8 | 0.6 | 0.7 | 0.9 | 0.7 | 0.6 | 1.5 |
| Mamanase | 0.7 | 0.05 | 0.045 | 0.06 | 0.04 | 0.045 | 0.1 |
| Amylase 1 | | | 0.3 | 0.1 | | | |
| Amylase 2 | | 0.1 | 0.1 | | 0.07 | | |
| Amylase4 | 0.3 | 0.1 | | 0.15 | 0.03 | 0.4 | 0.1 |
| Isoamylase | 0.3 | 0.2 | 0.1 | 0.07 | 0.2 | 0.02 | 0.3 |
| Xyloglucanase | 0.2 | 0.1 | | | 0.05 | 0.05 | 0.2 |
| Lipase | 0.4 | 0.2 | 0.3 | 0.1 | 0.2 | | |
| Polishing enzyme | | 0.04 | | 0.004 | | | |
| Extracellular-polymer degrading enzyme | | | | | | | |
| Dispersin B | | | | 0.05 | 0.03 | 0.001 | 0.001 |
| Acid Violet 50 | 0.05 | | | | | | 0.05 |
| Direct Violet 9 | | | | | | 0.05 | |
| Violet DD | | 0.035 | 0.02 | 0.037 | 0.04 | | |
| Water insoluble plant fiber | 0.2 | | | | 1.2 | | |
| Dye control agent | | 0.3 | | 0.5 | 0.3 | | |
| Alkoxylated polyaryl polyalkyl phenol | | | 1.2 | | | | 3.1 |

| | |
|---|---|
| Water, dyes & minors | Balance |
| pH | 8.2 |

AE1.85 is C1215 alkyl ethoxy (1.8) sulfate
AE3S is C1215 alkyl ethoxy (3) sulfate
AE7 is C1213 alcohol ethoxylate, with an average degree of ethoxylation of 7
AE8 is C1213 alcohol ethoxylate, with an average degree of ethoxylation of 8
AE9 is C1213 alcohol ethoxylate, with an average degree of ethoxylation of 9
Alkoxylated polyaryl is, for example, EMULSOGENC ® T5160, HOSTAPAL ®
BV conc., SAPOGENAT ® T11O, and/or SAPOGENAT ® T139, all from Clariant
Amylase 1 is STAINZYME ®, 15 mg active/g
Amylase 2 is NATALASE ®, 29 mg active/g
Amylase 3 is STAINZYME PLUS ®, 20 mg active/g
Isoamylase has glycogen-debranching activity
AS is C1214 alkylsulfate
Cellulase 2 is CELLUCLEAN ®, 15.6 mg active/g
Xyloglucanase is WHITEZYME ®, 20 mg active/g
Chelant 1 is diethylene triamine pentaacetic acid (DTPA)
Chelant 2 is 1-hydroxyethane 1,1-diphosphonic acid (HEDP)
Chelant 3 is sodium salt of ethylenediamine-N,N′-disuccinic acid, (S,S) isomer (EDDS)
Dispersin B is a glycoside hydrolase, reported as 1000 mg active/g
DTI 1 is poly(4-vinylpyridine-l-oxide), such as CHROMABOND S-403E ® ),
DTI 2 is poly(1-vinylpyrrolidone-co-l-vinylimidazole) (such as SOKALAN HP56 ©).
Dye control agent is, for example, SUPAREX ® O.IN (Ml), NYLOFIXAN ® P (M2),
NYLOFIXAN ® PM (M3), or NYLOFIXAN ® HF (M4)
HSAS is mid-branched alkyl sulfate as disclosed in U.S. Pat. No. 6,020,303 and
U.S. Pat. No. 6,060,443
LAS is linear alkylbenzenesulfonate having an average aliphatic carbon chain length
C9-C15 (HLAS is acid form)
Lipase is LIPEX ®, 18 mg active/g
Mannanase is MANNAWAY ®, 25 mg active/g
Optical Brightener 1 is disodium 4,4′-bis{[4-anilino-6-morpholino-s-triazin-2-yl]-
amino}-2,2-stilbenedisulfonate
Optical Brightener 2 is disodium 4,4′-bis-(2-sulfostyryl)biphenyl (sodium salt)
Optical Brightener 3 is OPTIBLANC SPL1O ® from 3 V Sigma
Perfume encapsulate is a core-shell melamine formaldehyde perfume microcapsules, obtainable
from Encapsys
Photobleach is a sulfonated zinc phthalocyanine
Polishing enzyme is Para-nitrobenzyl esterase, reported as 1000 mg active/g
Polymer 1 is bis((C2H5O)(C2H4O)n)(CH3) -N -CH----N′----(CH3)-bis ((C2H50)(C2H40)n), wherein
n = 20-30, x = 3 to 8, or sulphated or sulfonated variants thereof
Polymer 2 is ethoxylated (EO15) tetraethylene pentamine
Polymer 3 is ethoxylated polyethylenimine (PEI600 EO20)
Polymer 4 is ethoxylated hexamethylene diamine, Baxxodur © ECX 210 from BASF SE,
Baxxodur © EC 301 from BASF SE, and/or a polyetheramine comprising 1 mol
2-butyl-2-ethyl-1,3-propanediol + 5.0 mole propylene oxide, aminated.
Polymer 5 is ACUSOL ® 305, provided by Rohm&Haas
Polymer 6 is a polyethylene glycol polymer grafted with vinyl acetate side chains,
provided by BASF
Protease is PURAFECT PRIME ®, 40.6 mg active/g
Protease 2 is SAVINASE ® , 32.89 mg active/g
Protease 3 is PURAFECT ® , 84 mg active/g
Quaternary ammonium is C1214 Dimethylhydroxyethyl ammonium chloride
S-ACMC is Reactive Blue 19 Azo-CM-Cellulose, provided by Megazyme
Soil release agent is REPEL-O-TEX ® SF2
Structurant is Hydrogenated Castor Oil
Violet DD is a thiophene azo dye provided by Milliken
Water insoluble plant material is, for example, Herbacel AQ+ Type N, supplied by
Herbafood Ingredients GmbH, Werder, Germany

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a liquid consumer product in a container, the process comprising the steps of:
(A) providing a container that has an opening, wherein the total volume of said container ranges from about 10 ml to about 10 liters;
(B) partially filling said container with a first liquid feed composition to from about 0.01% to about 75% of the total volume of said container,
the first liquid feed composition comprising an enzyme, a first adjunct, and less than about 50% water, by weight of the first liquid feed composition;
(C) subsequently, filling the remaining volume of the container, or a portion thereof, with a second liquid feed composition, the second liquid feed composition being different from the first liquid feed composition, the second liquid feed composition comprising at least a second adjunct.

2. The process according to claim 1, wherein during step (B), the container is partially filled with the first liquid feed composition to from about 0.5% to about 50%, of the total volume of said container.

3. A process according to claim 1, wherein the enzyme comprises a protease enzyme, a non-protease enzyme, or a combination thereof.

4. A process according to claim 1, wherein the first adjunct comprises perfume, colorants, organic solvents, surfactants, opacifiers, pearlescent aids, brighteners, bleaches, bleach activators, catalysts, chelant, builder, polymer, structurant, or mixtures thereof,
in an amount that is at least 50% by weight of the first liquid feed composition.

5. A process according to claim 4, wherein the first adjunct comprises organic solvent, preferably wherein the organic solvent is selected from propylene glycol, dipropylene glycol, phenoxy ethanol, diethylene glycol, glycerin, isopropyl myristate, polyethylene glycol, an alkanolamine, or combinations thereof.

6. A process according to claim 5, wherein the weight ratio of the organic solvent to the water in the first liquid component is from about 0.75:1 to about 20:1.

7. A process according to claim 4, wherein the first adjunct comprises perfume,
wherein the perfume comprises neat perfume, encapsulated perfume, perfume premixed with a liquid carrier, or mixtures thereof.

8. A process according to claim 1, wherein the step of providing the first liquid feed composition to the container comprises at least two sub-steps, wherein the at least two sub-steps comprise:
i) providing a first enzyme premix to the container,
and at least one additional sub-step selected from the following:
ii) providing a second enzyme premix to the container;
iii) providing the first adjunct, preferably an organic solvent, dye, perfume, or mixtures thereof, to the container;
iv) combinations thereof.

9. A process according to claim 8, the process comprising the sub-steps i) and ii),
wherein the first enzyme premix comprises a protease enzyme, and
wherein the second enzyme premix comprises one or more non-protease enzymes.

10. A process according to claim 8, wherein the process comprises sub-step iii), wherein at least two materials are added in at least two filling steps.

11. The process according to claim 1, wherein during step (C), at least 50% of the total volume of said container is filled with said second liquid feed composition.

12. The process according to claim 1, wherein the second liquid feed composition comprises greater than 40% water.

13. A process according to claim 1, wherein the weight ratio of the first liquid feed composition to the second liquid feed composition is less than or equal to 1:1.

14. A process according to claim 1, wherein the first and/or second adjunct comprises a detersive surfactant, a conditioning agent, or a combination thereof.

15. A process according to claim 14, wherein the detersive surfactant is present in the second liquid component at a level of from about 5% to about 60%, by weight of the second liquid feed composition.

16. The process according to claim 1, wherein the liquid consumer product comprises greater than about 40% water, by weight of the liquid consumer product.

17. A process according to claim 1, wherein the liquid consumer product is characterized by a retained activity of the enzyme of:
at least about 0.85, measured four weeks after the liquid consumer product is made; and/or
at least about 0.60, measured twelve months after the liquid consumer product is made.

18. A process according to claim 1, wherein the process occurs on a manufacturing line having a plurality of filling stations,
wherein the first liquid feed composition is provided at one or more filling stations,
wherein the second liquid feed composition is provided at one or more different filling stations, and
wherein material is provided to the container at a total of from 2 to 10 filling stations.

19. A process according to claim 1, wherein the manufacturing system does not include a dedicated mixing station.

20. The process according to claim 1, wherein the peak flow rate of the first and/or second liquid feed composition ranges from about 5 mL/second to about 10 L/second.
